(19) United States
(12) Patent Application Publication
(10) Pub. No.: US 2026/0346633 A1
(43) Pub. Date: Nov. 5, 2026

(54) COUNTERFEIT PREVENTION METHOD FOR ARTWORKS

(71) Applicant: DigitART Global, S.L., Encinarejo de Cordoba (ES)

(72) Inventors: Enrique Garcia Salcines, Encinarejo de Córdoba (ES); Joaquin Aguilar Cordon, Encinarejo de Córdoba (ES)

(21) Appl. No.: 19/711,303

(22) Filed: Jun. 17, 2026

Related U.S. Application Data
(60) Provisional application No. 63/790,432, filed on Apr. 17, 2025.

(51) Int. Cl. B42D 25/387; B42D 25/328; B42D 25/337; B42D 25/355; G06K 19/06; G09F 3/00

(52) U.S. Cl. CPC B42D 25/387; G06K 19/06037; G09F 3/0292; G09F 3/0294; B42D 25/328; B42D 25/337; B42D 25/355

(57) ABSTRACT

A counterfeit prevention and authentication system for artworks is described. The system includes a steganographic security label configured to irreversibly fragment upon tampering or attempted removal, thereby providing visible tamper evidence and preventing unauthorized reuse. The label includes covert and overt security features including ultraviolet-visible elements, perforated die-cut structures, microtext, QR codes, NFC elements, and optical verification features. The label is affixed to an artwork using a specialized high-adhesion and chemically neutral adhesive configured for controlled superficial penetration into porous artwork supports without damaging the artwork. The adhesive further includes a verifiable chemical signature detectable through Raman spectroscopy. The system additionally provides hybrid physical and digital verification using ultraviolet, infrared, polarized optical inspection, and blockchain-based authentication records accessible through QR code or NFC interaction.

### CROSS REFERENCE TO RELATED APPLICATIONS

This application claims priority from a U.S. Provisional patent Appl. No. 63/790,432, filed on Apr. 17, 2025, which is incorporated herein by reference in its entirety.

### FIELD OF INVENTION

The present invention generally relates to systems and methods for protection and authentication of artworks and collectible visual media. More particularly, the present invention relates to a counterfeit prevention method and authentication system for artworks utilizing a tamper-evident steganographic security label, a specialized irreversible adhesive mechanism, and a hybrid physical-digital verification architecture configured to establish authenticity, ownership traceability, and anti-counterfeiting protection for visual artworks.

### BACKGROUND

The global art market continues to experience substantial economic losses and reputational harm due to the widespread circulation of counterfeit artworks. Counterfeit art generally includes forged, altered, copied, or fraudulently attributed works intentionally presented as authentic creations of recognized artists, historical periods, or cultural origins for financial gain. The increasing commercial value of original artworks has correspondingly stimulated the sophistication, scale, and organization of art forgery activities worldwide.

Industry reports and academic studies estimate that a significant percentage of artworks circulating within galleries, auctions, online marketplaces, museums, and private collections may be counterfeit or improperly authenticated. The existence of forged artworks undermines market confidence, creates legal disputes regarding ownership and provenance, and exposes collectors, institutions, and investors to substantial financial risks.

Conventional authentication approaches have attempted to address such challenges through the issuance of certificates of authenticity prepared by experts, artists, galleries, or appraisal institutions. However, such certificates are frequently dependent upon subjective expert analysis, provenance documentation, or historical interpretation, all of which may be vulnerable to human error, manipulation, duplication, or fraudulent reproduction.

Additional anti-counterfeiting techniques include the use of adhesive labels, serial numbering systems, barcodes, holographic stickers, RFID tags, and digital registration databases. While such methods may provide limited traceability or inventory management functions, they often fail to ensure permanent association with the artwork and may be susceptible to removal, replacement, cloning, or tampering without detectable evidence.

More recently, blockchain-based registration platforms and centralized digital authentication systems have been proposed to improve provenance tracking and ownership transparency. Although such technologies may enhance record immutability and transaction history, these systems generally lack integrated physical security mechanisms directly associated with the artwork itself. Consequently, a disconnect may remain between the physical object and its corresponding digital identity.

Certain advanced scientific authentication methods, including Raman spectroscopy, chemical fingerprinting, nanoparticle tagging, ultraviolet analysis, and forensic material examination, have also been developed. However, these techniques typically require expensive laboratory equipment, specialized technical personnel, and controlled testing environments, thereby limiting widespread practical implementation for artists, collectors, galleries, and smaller institutions.

Furthermore, many existing solutions operate independently as either physical security systems or digital verification platforms, without providing a unified authentication framework capable of simultaneously addressing tamper resistance, ownership verification, traceability, and real-time authentication.

Accordingly, there exists a need for an improved counterfeit prevention and authentication system for artworks that integrates physical protection features, secure digital verification, tamper-evident identification technology, and connectivity-based authentication mechanisms into a unified and commercially practical solution.

The present invention addresses the foregoing deficiencies by providing a comprehensive artwork authentication and counterfeit prevention method configured to securely associate a unique steganographic security identifier with an artwork through a tamper-resistant attachment mechanism and a corresponding digital verification infrastructure.

### SUMMARY OF THE INVENTION

The following presents a simplified summary of one or more embodiments of the present invention to provide a basic understanding of certain features and advantages thereof. This summary is not an exhaustive overview of all contemplated embodiments and is not intended to identify key or critical elements of the invention or to delineate the scope of the claims. Rather, it introduces selected concepts that are further described in the detailed description.

The principal object of the present invention is directed to a comprehensive method for identification, protection, and authentication of artworks that combines a steganographic security label, a specialized adhesive, hybrid verification methods (physical and digital), and a blockchain-based digital platform.

The present invention provides a counterfeit prevention and authentication system and method for artworks and collectible visual media. The invention integrates tamper-evident physical security structures, covert and overt authentication features, specialized adhesive technology, and digital verification infrastructure into a unified authentication framework configured to improve authenticity verification, ownership traceability, and counterfeit resistance.

In an exemplary embodiment, the invention provides a steganographic security label configured for secure attachment to an artwork or an associated support structure. The steganographic security label includes multiple anti-counterfeiting and tamper-evident features configured to inhibit unauthorized reproduction, substitution, transfer, reconstruction, or manipulation of the label.

In certain embodiments, the steganographic security label comprises a first set of ultraviolet-visible security elements configured to form concealed alignment patterns, a second set of ultraviolet-visible security elements extending across tamper-evident regions of the label, and a third set of physically formed tamper-destruction elements including perforations, die-cut structures, laser-scored regions, weakened regions, or combinations thereof.

The first and second sets of security elements may comprise covert optical security features substantially invisible under normal visible illumination and detectable under ultraviolet inspection. The third set of elements is configured to mechanically fragment, tear, or destruct the label upon attempted removal or tampering, thereby substantially preventing unauthorized reuse or reconstruction of the label.

In certain embodiments, the steganographic security label further includes additional authentication features including QR codes, NFC elements, ultraviolet-visible microtext, No-IR numbering, No-IR microtext, fluorescent invisible ink markings, latent polarized optical images, holographic elements, guilloché patterns, security fibers, microprinting, or combinations thereof.

In an exemplary embodiment, the steganographic security label is affixed using a specialized adhesive composition configured to provide high adhesion, chemical neutrality, tamper resistance, and controlled superficial penetration into porous artwork support materials including canvas, watercolor paper, archival paper, or other artistic substrates.

In certain embodiments, the adhesive composition penetrates only superficially into the artwork support, for example within a controlled penetration range of approximately 30 μm to 38 μm, thereby ensuring secure attachment while substantially preventing damage, degradation, or alteration of the artwork.

The adhesive composition may further comprise detectable chemical markers or chemical fingerprinting characteristics identifiable through Raman spectroscopy. In exemplary embodiments, the adhesive exhibits characteristic Raman spectral peaks at approximately 1652 cm⁻¹ and 1666 cm⁻¹ to facilitate forensic verification and authentication.

The present invention further provides a hybrid authentication and verification system integrating physical verification mechanisms with digital verification infrastructure. Physical verification may include ultraviolet inspection, infrared inspection, polarized optical inspection, microscopic inspection, Raman spectroscopy analysis, or combinations thereof.

Digital verification may be performed through scanning of a QR code or interaction with an NFC element associated with the steganographic security label. The digital verification system may provide access to authentication records, provenance data, ownership information, transfer history, exhibition records, condition reports, or other artwork-related metadata.

In certain embodiments, artwork-related information and authentication records are stored within a blockchain infrastructure, distributed ledger system, tamper-resistant database, or hybrid on-chain/off-chain storage architecture configured to provide immutable traceability and secure verification functionality.

The invention further provides a registration and verification platform configured to associate the steganographic security label with corresponding artwork registration records and authentication data. The platform may be accessed through one or more user devices including smartphones, tablets, laptops, desktop computers, or dedicated verification terminals.

Advantageously, the disclosed invention provides a multilayer authentication architecture combining physical tamper evidence, covert optical security features, forensic chemical verification, blockchain-enabled traceability, and digital ownership verification within a commercially scalable and conservation-compatible framework.

The disclosed system and method thereby provide improved counterfeit resistance, authentication reliability, ownership traceability, forensic verification capability, and long-term protection for artworks and collectible visual media while remaining commercially practical and suitable for widespread adoption.

### BRIEF DESCRIPTION OF DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 illustrates a front perspective view of a steganographic security label incorporating anti-counterfeiting and tamper-evident features, in accordance with an exemplary embodiment of the present invention.

FIG. 2 illustrates an exemplary configuration of perforated die-cut patterns formed within the steganographic security label to facilitate irreversible tamper indication upon attempted removal, in accordance with an exemplary embodiment of the present invention.

FIG. 3 illustrates a schematic block diagram representing a two-stage artwork registration, authentication, and verification process utilizing both physical inspection tools and digital verification mechanisms, in accordance with an exemplary embodiment of the present invention.

FIG. 4 illustrates a microphotographic image demonstrating controlled adhesive penetration within a range of approximately 30 μm to 38 μm into porous substrates including canvas and watercolor paper, thereby ensuring secure attachment while substantially preventing damage to the artwork, in accordance with an exemplary embodiment of the present invention.

FIG. 5 illustrates a Raman spectroscopy profile identifying characteristic adhesive spectral peaks at approximately 1652 cm⁻¹ and 1666 cm⁻¹ utilized for chemical authentication and verification of the anti-counterfeiting system, in accordance with an exemplary embodiment of the present invention.

### DETAILED DESCRIPTION

The subject matter of the present invention will now be described more fully with reference to the accompanying drawings, which form a part of this disclosure and illustrate specific exemplary embodiments. However, it should be understood that the subject matter may be embodied in various forms and is not limited to the specific embodiments set forth herein. Rather, these embodiments are provided by way of example to convey the scope of the invention. It is intended that the claims encompass a broad range of subject matter, including methods, devices, components, and systems. Accordingly, the following detailed description is not intended to be taken in a limiting sense.

As used herein, the term “exemplary” is intended to mean “serving as an example, instance, or illustration.” Any embodiment described as “exemplary” should not be construed as preferred or more advantageous over other embodiments. Similarly, the expression “embodiments of the present invention” does not imply that all embodiments must include all features, advantages, or modes of operation described.

The terminology used herein is for the purpose of describing particular embodiments only and is not intended to be limiting. As used herein, the singular forms “a,” “an,” and “the” include plural references unless the context clearly dictates otherwise. Furthermore, the terms “comprises,” “comprising,” “includes,” and/or “including” specify the presence of stated features, integers, steps, operations, elements, or components, but do not preclude the presence or addition of one or more other features, integers, steps, operations, elements, components, and/or groups thereof.

The following detailed description sets forth the best currently contemplated modes for carrying out exemplary embodiments of the invention. This description is not intended to be limiting, but rather to illustrate the general principles of the invention. The claims of any issued patent will define the scope of the invention.

The present invention relates to a counterfeit prevention and authentication method for artworks and collectible visual media. More specifically, the invention provides a steganographic security label configured for secure attachment to an artwork, wherein the label is designed to undergo irreversible fragmentation or structural degradation upon any attempted tampering, removal, transfer, or unauthorized manipulation.

In an exemplary embodiment, the steganographic security label is affixed to the artwork using a specialized high-adhesion, chemically neutral adhesive composition. The adhesive is configured to provide secure attachment while maintaining compatibility with delicate artistic substrates, including canvas, watercolor paper, and other porous or semi-porous supports. The adhesive further possesses identifiable chemical characteristics capable of verification through Raman spectroscopy analysis.

In certain embodiments, the adhesive penetrates only superficially into the support material of the artwork within a controlled penetration range sufficient to ensure inviolability and tamper resistance without substantially altering, damaging, or degrading the physical integrity or aesthetic characteristics of the artwork.

The invention further provides a hybrid verification system and authentication method combining physical inspection mechanisms and digital verification technologies. The physical verification mechanisms may include ultraviolet inspection, infrared inspection, polarized optical analysis, microscopic inspection, Raman spectroscopy, or combinations thereof. The digital verification technologies may include QR codes, NFC devices, encrypted identifiers, blockchain-based authentication records, or equivalent digital traceability systems.

In an exemplary implementation, digital verification enables authorized users to securely access artwork-related information, including authenticity records, ownership history, provenance data, registration information, transaction logs, and verification events stored within a distributed ledger or blockchain infrastructure.

The invention additionally provides an integrated digital platform configured to facilitate artwork registration, authentication management, ownership tracking, verification processing, and secure data administration associated with the protected artwork.

Advantageously, the disclosed system and method provide a robust, tamper-evident, commercially scalable, and cost-effective solution capable of comprehensively addressing challenges associated with artwork authenticity, counterfeit prevention, ownership traceability, and long-term security within the art market ecosystem.

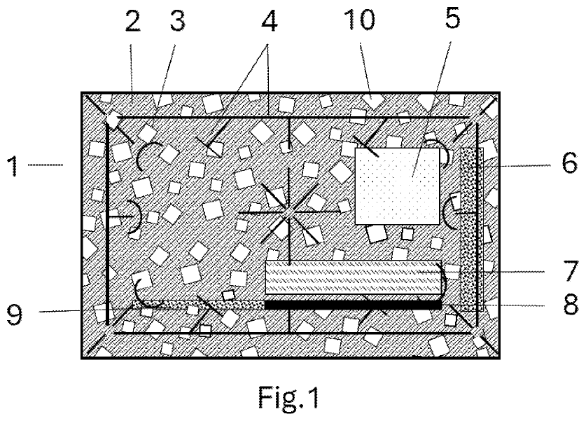

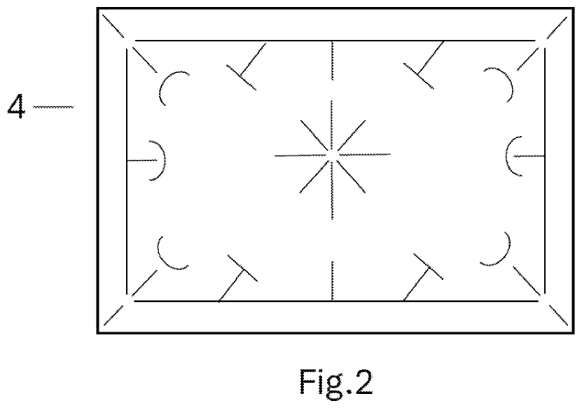

Referring to FIGS. 1 and 2, an exemplary embodiment of a steganographic security label 1 configured for counterfeit prevention and authentication of artworks is illustrated. The steganographic security label 1 comprises a plurality of anti-counterfeiting and tamper-evident elements configured to inhibit unauthorized reproduction, duplication, transfer, or manipulation of the label.

In an exemplary embodiment, the steganographic security label 1 is structurally configured to undergo irreversible fragmentation, tearing, deformation, or destruction upon any attempted removal or tampering, thereby providing visible evidence of unauthorized interference and substantially preventing reuse of the label on another artwork.

The steganographic security label 1 may be affixed to a rear side or non-visible portion of the artwork so as to preserve the aesthetic appearance of the artwork while maintaining secure authentication functionality. In certain embodiments, the label may be attached directly to a substrate or support associated with the artwork, including but not limited to a canvas rear surface, stretcher frame, backing board, watercolor paper support, frame backing, mounting panel, or other concealed structural region associated with the artwork.

In certain embodiments, the steganographic security label 1 further includes embedded security information, machine-readable identifiers, covert authentication features, steganographic patterns, optical verification elements, or digitally linked authentication data configured to cooperate with physical and digital verification systems associated with the present invention.

In an exemplary embodiment, the steganographic security label 1 comprises a first set of security elements 2 configured to be substantially transparent under visible light conditions and detectable under ultraviolet illumination. The first set of security elements 2 is arranged to prevent repositioning, reconstruction, or reassembly of fragmented portions of the label following tampering or attempted removal.

The steganographic security label 1 further comprises a second set of security elements 3 configured to be substantially transparent under normal viewing conditions and visible under ultraviolet illumination. In certain embodiments, the second set of security elements 3 extends across or intersects one or more cut regions, perforation regions, or tamper-destruction regions of the label so as to inhibit relocation, realignment, or unauthorized reconstruction of separated label portions.

In an exemplary embodiment, the steganographic security label 1 additionally comprises a third set of elements 4 including fine perforated die-cut structures, weakening regions, fracture-inducing patterns, tamper-destruction lines, or mechanically formed separation features configured to cause irreversible fragmentation, tearing, or destruction of the label upon attempted removal, transfer, or manipulation.

The first set of security elements 2 and the second set of security elements 3 may be formed using printing techniques known in the art, including ultraviolet-reactive printing, transparent ink deposition, microprinting, security ink printing, screen printing, flexographic printing, offset printing, digital printing, gravure printing, or combinations thereof.

In certain embodiments, the third set of elements 4 may be mechanically formed through die-cutting, laser cutting, micro-perforation, scoring, embossing, pressure weakening, or other material-fracture preparation techniques capable of producing controlled structural weakening of the label substrate.

The first set of elements 2, the second set of elements 3, and the third set of elements 4 may independently comprise linear, curved, continuous, discontinuous, segmented, geometric, irregular, patterned, symbolic, alphanumeric, microscopic, or customized configurations. Any arrangement, geometry, orientation, density, or pattern of such elements configured to provide tamper evidence, anti-counterfeiting functionality, or authentication capability shall be considered within the scope of the present invention.

In an exemplary embodiment, the first set of security elements 2 is configured to be substantially invisible, minimally visible, or optically unobtrusive under visible-spectrum illumination while becoming detectable, illuminated, fluorescent, or otherwise visually distinguishable under ultraviolet (UV) illumination.

In certain embodiments, the first set of security elements 2 may be formed through printing, coating, deposition, or application of ultraviolet-reactive materials including transparent UV-reactive ink, fluorescent varnish, ultraviolet-visible security ink, clear security lacquer, transparent polymeric compositions containing UV-reactive compounds, luminescent compounds, fluorescent pigments, phosphorescent materials, or combinations thereof.

The first set of security elements 2 may be applied using printing or deposition techniques known in the art, including screen printing, flexographic printing, offset printing, gravure printing, inkjet printing, digital security printing, microprinting, lithographic printing, or other controlled material deposition techniques capable of producing covert or semi-covert security features.

In certain embodiments, the first set of security elements 2 forms a concealed alignment pattern distributed across at least a portion of the surface of the steganographic security label 1. The concealed alignment pattern may comprise continuous lines, intersecting regions, encoded geometries, registration patterns, fragmented image components, microscopic features, or other coordinated structures configured to maintain positional continuity while the label remains intact.

Upon attempted removal, fragmentation, repositioning, reconstruction, or tampering of the steganographic security label 1, continuity of the concealed alignment pattern is disrupted, displaced, or permanently altered. During ultraviolet inspection, such discontinuity, misalignment, distortion, interruption, or deformation becomes visually detectable, thereby preventing unauthorized reassembly or repositioning of fragmented portions of the label without observable evidence of tampering.

Advantageously, the first set of security elements 2 provides a covert tamper-verification mechanism capable of enabling rapid authentication through non-destructive ultraviolet inspection while substantially increasing resistance to counterfeit reproduction and label reconstruction attempts.

In an exemplary embodiment, the second set of security elements 3 comprises additional ultraviolet-visible optical security features extending across, intersecting, or overlapping one or more physical cut regions, weakened regions, perforation regions, fracture-inducing regions, or tamper-evident portions of the steganographic security label 1.

The second set of security elements 3 may comprise optical security lines, registration markings, covert alignment features, encoded patterns, microscopic structures, or other ultraviolet-detectable indicia configured to cooperate with the tamper-evident structure of the label. In certain embodiments, the second set of security elements 3 does not itself constitute physical cuts or perforations, but rather optical verification features associated with such regions.

In certain embodiments, the second set of security elements 3 may be formed using transparent ultraviolet-reactive ink, fluorescent ink, invisible ink, clear ultraviolet security varnish, luminescent compositions, transparent polymeric security coatings, or combinations thereof. The second set of security elements 3 may be applied using screen printing, flexographic printing, gravure printing, digital security printing, offset printing, inkjet deposition, or other controlled printing or coating techniques known in the art.

In an exemplary implementation, the second set of security elements 3 forms a concealed registration pattern extending continuously across the tamper-evident die-cut regions, perforation regions, or structurally weakened portions of the steganographic security label 1. The concealed registration pattern is configured to maintain positional continuity while the label remains intact and properly affixed.

Upon attempted lifting, removal, cutting, fragmentation, transfer, reconstruction, or relocation of the steganographic security label 1, alignment of the second set of security elements 3 becomes disrupted, displaced, interrupted, or permanently altered. Under ultraviolet inspection, such discontinuity or misalignment becomes visually detectable, thereby providing evidence of tampering and substantially preventing unauthorized reuse or reconstruction of the label.

Advantageously, the second set of security elements 3 provides an additional covert verification layer operating in cooperation with the tamper-evident structural features of the label to enhance counterfeit resistance, tamper detection capability, and authentication reliability.

In an exemplary embodiment, the third set of elements 4 comprises fine perforated die-cut structures, micro-perforations, laser-scored lines, kiss-cut lines, mechanically weakened regions, fracture-inducing structures, or other physically formed tamper-destruction features integrated within the substrate of the steganographic security label 1. Unlike the first set of security elements 2 and the second set of security elements 3, which primarily comprise printed or optically deposited security features, the third set of elements 4 comprises physically formed structural weakening regions configured to mechanically compromise the integrity of the label upon attempted removal, lifting, transfer, or tampering.

In certain embodiments, the third set of elements 4 is configured to cause irreversible fragmentation, tearing, separation, distortion, or destruction of the steganographic security label 1 when subjected to removal forces or unauthorized manipulation, thereby substantially preventing intact removal and reuse of the label on another artwork or support surface.

The third set of elements 4 may be produced using mechanical die-cutting, rotary die-cutting, laser scoring, laser ablation, micro-perforation processing, kiss-cutting, precision cutting, pressure weakening, or equivalent substrate-fracturing techniques capable of generating controlled tamper-destruction regions within the label substrate.

In preferred embodiments, the first set of security elements 2, the second set of security elements 3, and the third set of elements 4 are arranged as continuous or substantially continuous lines, intersecting patterns, encoded geometries, or distributed security configurations extending across at least a portion of the steganographic security label 1. The thickness, spacing, density, geometry, orientation, or continuity of such elements may vary without departing from the scope of the present invention.

The cooperative interaction between the first set of security elements 2, the second set of security elements 3, and the third set of elements 4 provides a multi-layer tamper-evident authentication structure. In particular, the die-cut or perforated structures physically destroy or fragment the label upon attempted removal, while the ultraviolet-visible optical security patterns reveal any attempted repositioning, reconstruction, reassembly, or alignment manipulation of fragmented portions of the label.

In certain embodiments, the first set of security elements 2 and the second set of security elements 3 comprise covert optical security features printed, coated, or deposited onto the label substrate, whereas the third set of elements 4 comprises physically formed tamper-destruction structures integrated within the substrate material of the label itself.

The steganographic security label 1 may be securely affixed to a rear side or non-visible support region associated with the artwork using the specialized adhesive composition disclosed herein, thereby providing secure attachment, tamper resistance, and long-term authentication functionality while substantially preserving the visible appearance and physical integrity of the artwork.

In certain embodiments, the steganographic security label 1 comprises a security substrate selected to provide tamper-evident functionality, archival compatibility, structural durability, and compatibility with artwork conservation requirements. The security substrate may comprise destructible security paper, destructible vinyl, polyethylene terephthalate (PET) film, polyester film, polypropylene film, archival-compatible polymeric film, multilayer polymeric film, composite security laminate, holographic security film, or combinations thereof.

In certain embodiments, the security substrate may further comprise embedded security components including fluorescent fibers, ultraviolet-reactive particles, luminescent materials, microscopic identifiers, watermark structures, optically variable features, holographic elements, embedded filaments, security threads, encoded particulate matter, or other covert or overt authentication structures.

The security substrate may be configured as a single-layer structure or a multilayer construction comprising one or more printable layers, tamper-destruction layers, adhesive-receiving layers, barrier layers, optical security layers, or protective coatings configured to enhance durability and counterfeit resistance.

In certain embodiments, the material composition, thickness, flexibility, porosity, tear characteristics, adhesive compatibility, optical properties, and conservation properties of the security substrate may be selected according to the characteristics of the artwork support surface, including canvas, paper, wood panel, fabric, cardboard, archival board, composite substrate, or other artistic support materials.

The security substrate may additionally be selected to satisfy archival preservation and conservation requirements by minimizing chemical migration, discoloration, mechanical stress, acidity, solvent interaction, moisture transfer, or degradation effects that could adversely affect the artwork over long-term storage, transport, exhibition, or environmental exposure conditions.

In certain embodiments, the steganographic security label 1 may further comprise one or more additional anti-counterfeiting and authentication features configured to enhance security, traceability, uniqueness, and verification capability associated with the protected artwork. Such additional security features may include, without limitation, a QR code, NFC element, sequential No-IR numbering, No-IR microtext, ultraviolet-visible microtext, fluorescent invisible ink markings, polarized-lens latent images, holographic security elements, guilloché patterns, microprinting, security fibers, optically variable features, encoded identifiers, machine-readable elements, or combinations thereof.

In certain embodiments, the foregoing security features may be incorporated into the same substrate of the steganographic security label 1 using security printing, coating, laminating, encoding, embossing, deposition, engraving, converting, or material integration techniques known in the art.

Referring to FIG. 1, the steganographic security label 1 may include a QR code 5 configured to provide connectivity and digital verification functionality. In certain embodiments, scanning of the QR code 5 enables access to authentication records, ownership information, provenance data, blockchain registration information, transaction history, or other digitally stored verification data associated with the artwork. FIG. 1 further illustrates sequential No-IR numbering 6 configured to uniquely identify each steganographic security label 1. In certain embodiments, the sequential No-IR numbering 6 comprises infrared-transparent or infrared-responsive printed identifiers configured for covert inspection and secure traceability.

In an exemplary embodiment, FIG. 1 further illustrates an encoded image 7 configured as a latent optical security feature visible only through a polarized lens and/or at a predetermined viewing angle. The encoded image 7 may comprise concealed graphics, authentication symbols, alphanumeric identifiers, security indicia, or covert visual information configured to resist unauthorized reproduction.

In certain embodiments, the steganographic security label 1 additionally comprises ultraviolet-visible microtext 8 configured to be substantially undetectable under normal visible illumination while becoming readable or identifiable under ultraviolet inspection.

The steganographic security label 1 may further comprise No-IR microtext 9 including microscopic alphanumeric characters, encoded symbols, or security information configured to increase counterfeit complexity and enable covert authentication through infrared or magnified inspection techniques.

In certain embodiments, fluorescent invisible ink markings 10 may additionally be incorporated into the steganographic security label 1. The fluorescent invisible ink markings 10 may comprise one or more colors and may remain substantially invisible under normal visible illumination while becoming detectable under ultraviolet illumination to provide additional covert authentication capability.

The combination of overt, covert, optical, digital, microscopic, ultraviolet-responsive, infrared-responsive, and machine-readable security features within the steganographic security label 1 provides a multilayer authentication architecture substantially increasing resistance to forgery, duplication, simulation, and unauthorized reproduction.

In an exemplary embodiment, the steganographic security label 1 is affixed to the artwork or associated support structure using a specialized adhesive composition configured to provide high adhesion, tamper resistance, chemical neutrality, and controlled superficial penetration into porous artwork support materials. In certain embodiments, the adhesive composition is configured to penetrate only superficially into porous or semi-porous support materials including canvas, watercolor paper, archival paper, fabric supports, cardboard, fiberboard, or other artistic substrates. The penetration depth may be controlled within a predetermined range, such as approximately 30 μm to 38 μm, thereby providing secure attachment and inviolability while substantially preventing damage, discoloration, deformation, or degradation of the artwork.

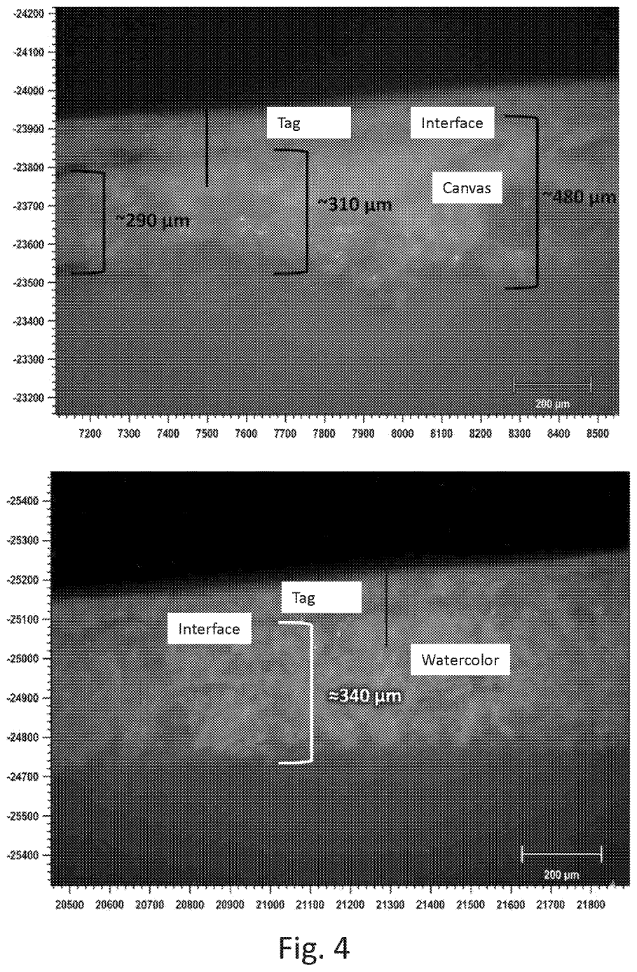

Referring to FIG. 4, a microphotographic image illustrating controlled adhesive penetration into porous artwork supports is shown. The controlled penetration profile enables formation of a highly resistant attachment zone while substantially preserving the physical integrity and aesthetic characteristics of the artwork support and visible artistic layers.

In certain embodiments, the adhesive composition may comprise a pressure-sensitive adhesive layer pre-applied to an underside of the steganographic security label 1 and protected by a removable release liner prior to application. In alternative embodiments, the adhesive may be applied immediately prior to installation of the steganographic security label 1 in the form of a controlled thin film, patterned coating, adhesive stripe, discontinuous adhesive region, micro-structured adhesive layer, or selectively deposited adhesive configuration.

In certain exemplary embodiments, the adhesive composition may comprise an acrylic pressure-sensitive adhesive, modified acrylic adhesive, archival-compatible acid-free adhesive, conservation-compatible polymeric adhesive, UV-curable acrylate adhesive, chemically neutral adhesive composition, or combinations thereof selected to provide strong adhesion while limiting excessive penetration into the artwork support substrate.

The adhesive composition may be applied during manufacture of the steganographic security label 1 using coating, transfer coating, lamination, screen coating, slot-die coating, gravure coating, spray deposition, patterned deposition, or other controlled adhesive application techniques known in the art.

During installation, the removable release liner may be detached and the steganographic security label 1 may be positioned and pressed onto a rear side or non-visible support region of the artwork under controlled pressure conditions. The adhesive composition is configured to produce a substantially permanent attachment resistant to removal, transfer, peeling, repositioning, or tampering.

In certain embodiments, the adhesive composition further includes one or more detectable chemical markers, spectral identifiers, or chemical fingerprinting components configured to enable forensic authentication and verification of the original attachment system.

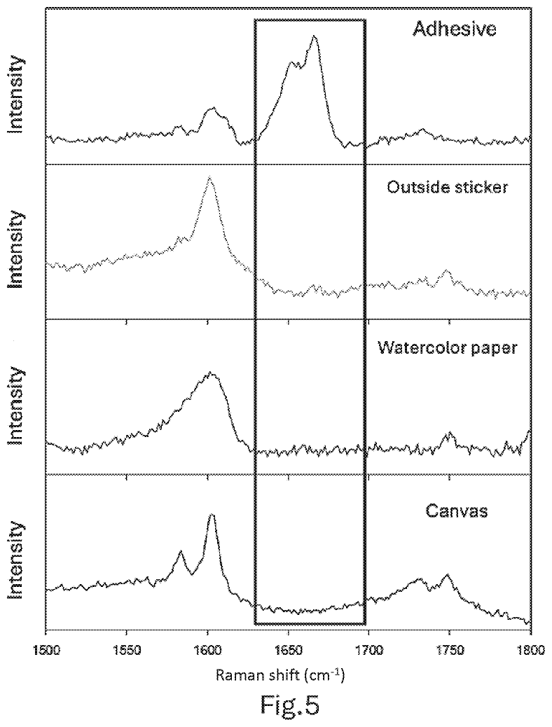

Referring to FIG. 5, an exemplary Raman spectroscopy profile associated with the adhesive composition is illustrated. In an exemplary embodiment, the adhesive composition exhibits characteristic Raman spectral peaks at approximately 1652 cm⁻¹ and 1666 cm⁻¹, thereby providing a detectable chemical authentication signature.

The Raman spectral peaks associated with the adhesive composition may be utilized to distinguish the original adhesive from substituted, counterfeit, altered, or unauthorized adhesive materials. In certain embodiments, the precise chemical composition and corresponding Raman signature may vary depending upon the selected adhesive formulation, and the cited spectral peaks are provided solely as exemplary embodiments.

Advantageously, the adhesive composition functions both as a mechanical anti-removal mechanism and as a chemical authentication feature associated with the steganographic security label 1. Upon attempted removal or tampering, the label undergoes irreversible fragmentation due to the tamper-destruction structures, while the adhesive composition remains detectable or leaves a verifiable chemical footprint associated with the original attachment region.

The cooperative interaction between the specialized adhesive composition and the tamper-evident label structure provides enhanced counterfeit resistance, attachment security, forensic traceability, and long-term authentication capability for artworks and collectible visual media.

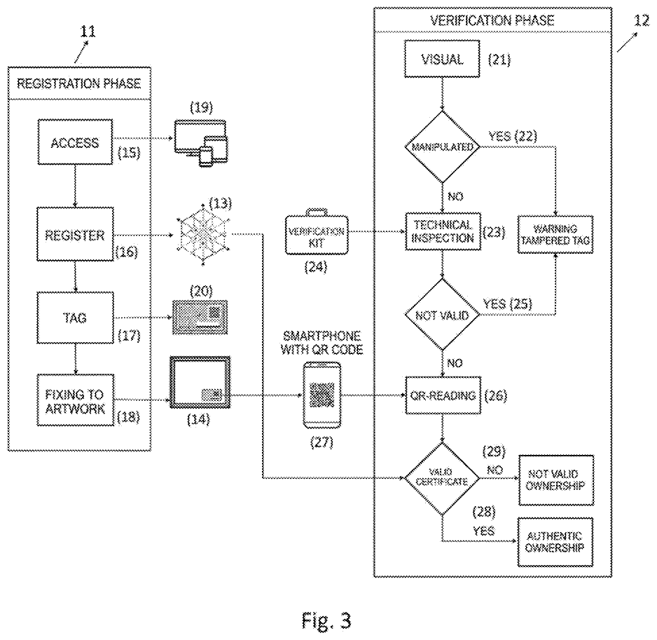

Referring to FIG. 3, the present invention further provides a system and method for registration, authentication, verification, traceability, and ownership management of artworks protected by the steganographic security label 1. In an exemplary embodiment, the system is configured to receive artwork data from one or more user devices associated with artists, galleries, collectors, institutions, authenticators, registrars, or authorized entities. The artwork data may comprise a set of digital information associated with identification, authentication, provenance tracking, ownership verification, registration, and traceability of an artwork and its corresponding steganographic security label 1.

In certain embodiments, the artwork data may be stored directly on a blockchain infrastructure, partially stored on-chain with associated cryptographic hashes, stored within an off-chain secure database, decentralized storage system, distributed file system, cloud infrastructure, or combinations thereof utilizing a hybrid storage architecture selected according to privacy, scalability, regulatory, and computational requirements.

The artwork data may include, without limitation, a unique artwork identifier, certificate identifier, serial number associated with the steganographic security label 1, QR code identifier, NFC identifier, artwork title, artist identifier, artist name, creation date, technique, material composition, substrate type, dimensions, edition number, edition size, image hash, perceptual fingerprint, digital certificate hash, provenance documentation hash, condition report hash, ownership identifier, wallet address, pseudonymous ownership reference, ownership transfer history, exhibition history, restoration history, custody events, authentication events, loan events, transaction events, registration timestamps, verifier identity, gallery information, institutional records, blockchain transaction identifiers, smart contract references, status indicators, or combinations thereof.

In preferred embodiments, sensitive personal information and confidential ownership data are not stored directly on a public blockchain. Instead, the blockchain infrastructure may store certificate identifiers, label identifiers, ownership state references, metadata hashes, event hashes, transaction records, smart contract references, or cryptographic proofs, while detailed documentation and personal information remain stored within a secure off-chain database or decentralized storage infrastructure. Such architecture advantageously preserves immutability, traceability, and tamper resistance associated with blockchain registration while maintaining privacy protection, data minimization, regulatory compliance, and controlled access to confidential information.

In certain embodiments, the blockchain record enables a user scanning the QR code 5 or interacting with an NFC element associated with the steganographic security label 1 to verify whether the physical label corresponds to a registered artwork, whether the certificate remains valid, whether ownership or custody information matches the maintained record, and whether any theft, dispute, invalidation, or replacement events have been recorded.

The artwork data and the corresponding steganographic security label 1 may be recorded by the system in a tamper-resistant database infrastructure 13 including blockchain systems, distributed ledger systems, cryptographically secured databases, immutable transaction ledgers, or combinations thereof. In certain embodiments, the stored metadata may include ownership information, provenance records, registration history, transfer events, verification records, artwork condition data, restoration history, insurance records, transaction data, or authentication-related information associated with the artwork. The system is configured to associate the digital registration record with the steganographic security label 1 physically affixed to a rear side or concealed support region of the artwork 18.

In an exemplary embodiment, the QR code 5 incorporated into the steganographic security label 1 may be scanned using a user device 19 including a smartphone, tablet computer, desktop computer, laptop computer, dedicated verification terminal, portable scanner, or other network-connected computing device. The user device 19 may comprise a processor, memory, camera module, wireless communication interface, display interface, scanning module, location module, authentication software, and network connectivity components configured to communicate with the registration and verification system.

Upon scanning the QR code 5 or interacting with an NFC element, a verification interface may be rendered on the user device 19. The verification interface may decode the identifier associated with the steganographic security label 1 and query the registration system for a corresponding authentication record.

In certain embodiments, the verification interface may retrieve and display ownership information, authenticity status, provenance records, registration information, transfer history, exhibition history, verification events, theft notifications, or other authorized metadata associated with the artwork.

Referring further to FIG. 3, the system includes a registration phase 11 and a verification phase 12. During the registration phase 11, artwork data associated with the artwork 18 and the steganographic security label 1 may be received from the user device 19 and registered within the tamper-resistant database infrastructure 13. In certain embodiments, the steganographic security label 1 may thereafter be affixed to a rear side 14 or concealed support region of the artwork 18, as illustrated at block 17, thereby establishing a physical association between the registered digital record and the artwork.

The verification phase 12 may include physical verification procedures, digital verification procedures, or combinations thereof. In an exemplary embodiment, physical verification may begin with visual inspection of the steganographic security label 1 to determine whether visible evidence of tampering, fragmentation, removal, misalignment, destruction, substitution, or alteration exists, as illustrated at block 21. If visual inspection indicates evidence of manipulation, tampering, substitution, or unauthorized alteration, a warning condition may be generated at block 22 and the artwork may be classified as potentially counterfeit, stolen, disputed, invalidated, or otherwise unauthorized, as represented at block 25. If the steganographic security label 1 appears visually intact, the label may be subjected to technical inspection procedures at block 23 utilizing a verification kit 24.

In certain embodiments, the verification kit 24 may include one or more ultraviolet illumination devices, infrared inspection devices, polarized viewing lenses, magnification devices, microscopes, Raman spectroscopy devices, optical filters, authentication readers, or combinations thereof configured to inspect covert and overt security features associated with the steganographic security label 1.

If technical inspection reveals counterfeit characteristics, tampering evidence, reconstruction attempts, feature inconsistencies, or absence of expected security indicators, the artwork may be designated as potentially counterfeit, stolen, invalidated, or unauthorized.

In certain embodiments, digital verification may be performed independently of physical verification, prior to physical verification, subsequent to physical verification, or concurrently therewith.

For digital verification, the QR code 5 or NFC element associated with the steganographic security label 1 may be scanned using the verification interface rendered on the user device 19, as illustrated at block 27. The system may query the tamper-resistant database infrastructure 13 or blockchain record at block 26 to determine whether an associated authentication record exists and whether the retrieved information corresponds to the scanned artwork identifier.

If no valid associated record is identified, if the record has been invalidated, or if inconsistencies are detected between the physical label and the digital registration data, the authenticity status of the artwork may be rejected, invalidated, flagged, or classified as suspicious, as illustrated at block 29.

If a valid corresponding authentication record is identified at block 28, the system may authenticate the artwork and provide verified ownership information, provenance records, certificate status, transaction history, or other authorized authentication data through the user device 19.

Advantageously, the disclosed hybrid verification architecture integrates physical tamper-evident security features with blockchain-enabled digital authentication infrastructure, thereby providing enhanced counterfeit resistance, ownership traceability, authentication reliability, forensic verification capability, and long-term security for artworks and collectible visual media.

The disclosed counterfeit prevention and authentication method provides numerous technical and commercial advantages over conventional artwork authentication systems. In certain embodiments, the cooperative interaction between the steganographic security label 1 and the specialized adhesive composition provides an inviolable and tamper-evident security mechanism configured to reveal attempted removal, substitution, repositioning, reconstruction, or unauthorized manipulation of the label. The integration of physical authentication mechanisms and digital verification infrastructure advantageously provides a multilayer authentication architecture capable of substantially improving reliability, counterfeit resistance, and verification accuracy associated with artworks and collectible visual media.

In certain embodiments, blockchain technology, distributed ledger infrastructure, or cryptographically secured database systems are utilized to register, protect, and maintain artwork data, ownership records, provenance information, transfer events, and authentication history in an immutable and tamper-resistant manner. The disclosed system thereby enables long-term traceability, ownership verification, provenance preservation, and secure authentication of artworks across transactions, exhibitions, transportation events, restoration procedures, and changes in ownership or custody.

In certain embodiments, the disclosed authentication method may be implemented using commercially scalable manufacturing and verification processes, thereby enabling rapid deployment and broad adoption within galleries, museums, auction houses, collectors, artists, archives, insurers, and authentication institutions. The disclosed system is further advantageous in that it may be implemented using relatively low-cost security printing, label fabrication, adhesive application, and digital registration technologies, thereby increasing accessibility and commercial practicality compared with laboratory-dependent forensic authentication systems.

In certain embodiments, the physical verification hardware may be configured as portable authentication kits including ultraviolet inspection devices, infrared inspection devices, polarized optical filters, magnification tools, Raman spectroscopy devices, or combinations thereof, thereby enabling field-based verification and decentralized authentication operations. The portability and modularity of the verification tools advantageously facilitate scalability, mobile authentication capability, institutional deployment, and widespread adoption across diverse art market environments.

The disclosed system therefore provides a unified authentication ecosystem integrating tamper-evident physical protection, covert and overt security features, forensic verification capability, blockchain-enabled traceability, and digital ownership verification within a commercially practical and conservation-compatible framework.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A counterfeit prevention and authentication system for artworks, the system comprising:
a steganographic security label configured for attachment to an artwork or to an associated support structure of the artwork, wherein the steganographic security label comprises:
at least one covert optical security element configured to be detectable under non-visible or conditioned inspection;
at least one physically formed tamper-destruction element configured to irreversibly fragment, tear, deform, or destruct the steganographic security label upon attempted removal or tampering; and
a machine-readable identifier; wherein disruption, misalignment, fragmentation, tearing, deformation, or destruction of the steganographic security label provides detectable evidence of tampering and alters the machine-readable identifier to prevent unauthorized verification.

2. The system as claimed in claim 1, wherein the at least one covert optical security element comprises:
a first set of ultraviolet-reactive security elements configured to form a concealed alignment pattern; and
a second set of ultraviolet-reactive security elements extending across one or more tamper-evident regions of the steganographic security label;
wherein the at least one physically formed tamper-destruction element comprises a third set of physically formed tamper-destruction elements comprising perforations, die-cut regions, weakened regions, laser-scored regions, or combinations thereof.

3. The system as claimed in claim 2, wherein the first set of ultraviolet-reactive security elements and the second set of ultraviolet-reactive security elements comprise transparent ultraviolet-reactive ink, fluorescent ink, invisible ink, ultraviolet-visible security varnish, luminescent compositions, transparent polymeric security coatings, or combinations thereof.

4. The system as claimed in claim 2, wherein the second set of ultraviolet-reactive security elements extends across perforation regions, die-cut regions, weakened regions, laser-scored regions, or tamper-destruction regions of the steganographic security label to reveal tampering through disruption of positional alignment.

5. The system as claimed in claim 1, wherein the at least one physically formed tamper-destruction element is formed by die-cutting, rotary die-cutting, laser scoring, laser ablation, micro-perforation, kiss-cutting, precision cutting, pressure weakening, or combinations thereof.

6. The system as claimed in claim 1, wherein the machine-readable identifier is a QR code, the steganographic security label further comprises an NFC element, sequential non-infrared (No-IR) numbering, No-IR microtext, ultraviolet-visible microtext, fluorescent invisible ink markings, a latent polarized optical image, a holographic element, a guilloché pattern, microprinting, or security fibers.

7. The system as claimed in claim 1, wherein the steganographic security label comprises a security substrate selected from destructible security paper, destructible vinyl, polyethylene terephthalate film, polyester film, polypropylene film, archival-compatible polymeric film, multilayer polymeric film, composite security laminate, holographic security film, or combinations thereof.

8. The system as claimed in claim 1, further comprising an adhesive composition configured for affixing the steganographic security label to the artwork or to the associated support structure, wherein the adhesive composition is chemically neutral and configured to provide high adhesion and controlled superficial penetration into a porous or semi-porous artwork support to create a permanent mechanical bond without causing visible degradation to the artwork surface.

9. The system as claimed in claim 8, wherein the adhesive composition is configured to penetrate the porous or semi-porous artwork support within a controlled penetration depth range of approximately 30 μm to 38 μm.

10. The system as claimed in claim 8, wherein the adhesive composition comprises a pressure-sensitive adhesive, acrylic pressure-sensitive adhesive, modified acrylic adhesive, archival-compatible acid-free adhesive, conservation-compatible polymeric adhesive, UV-curable acrylate adhesive, chemically neutral adhesive composition, or combinations thereof.

11. The system as claimed in claim 8, wherein the adhesive composition comprises a detectable chemical signature identifiable through Raman spectroscopy.

12. The system as claimed in claim 11, wherein the detectable chemical signature comprises Raman spectral peaks at approximately 1652 cm⁻¹ and 1666 cm⁻¹.

13. The system as claimed in claim 1, further comprising a physical verification kit configured to inspect the steganographic security label, the physical verification kit including one or more of: an ultraviolet inspection device, an infrared inspection device, a polarized viewing lens, a magnification device, a microscope, a Raman spectroscopy device, an optical filter, or an authentication reader.

14. The system as claimed in claim 1, further comprising a digital verification platform configured to cryptographically bind the machine-readable identifier of the steganographic security label to a digital record containing artwork authentication data, wherein physical tampering with the steganographic security label invalidates the cryptographic binding, thereby providing a technical solution to artwork counterfeiting.

15. The system as claimed in claim 14, wherein the digital verification platform comprises a blockchain, distributed ledger, cryptographically secured database, tamper-resistant database, or hybrid on-chain/off-chain storage architecture.

16. The system as claimed in claim 15, wherein the blockchain, distributed ledger, cryptographically secured database, tamper-resistant database, or hybrid on-chain/off-chain storage architecture stores at least one of: a certificate identifier, a security label identifier, a cryptographic hash of artwork metadata, a cryptographic hash of a certificate of authenticity, an ownership state reference, a custody event reference, a transfer event reference, an invalidation event reference, a smart contract reference, or a transaction identifier.

17. A method for counterfeit prevention and authentication of artworks, the method comprising:
providing a steganographic security label comprising:
at least one covert optical security element,
at least one physically formed tamper-destruction element, and
a machine-readable identifier;
affixing the steganographic security label to an artwork or to an associated support structure using an adhesive composition configured to provide controlled superficial penetration into the artwork support;
physically verifying the steganographic security label by inspecting at least one covert optical security element or at least one tamper-destruction element; and
digitally verifying the artwork by using a computing device to scan the machine-readable identifier and query a distributed ledger or cryptographically secured database, wherein the digital verification confirms a cryptographic binding between the machine-readable identifier and artwork metadata.

18. The method as claimed in claim 17, further comprising comparing an identifier obtained from the machine-readable identifier with a corresponding artwork registration record and displaying, on a user device, at least one of:
an authenticity status,
certificate status,
ownership status,
provenance record,
custody record,
transfer history,
theft status,
dispute status,
invalidation status,
replacement status, or
warning condition associated with the artwork.

19. A hybrid physical-digital authentication system for artworks, comprising:
a steganographic security label physically affixed to an artwork support, comprising:
tamper-destruction elements configured to irreversibly fragment upon removal;
a machine-readable identifier integrated into the steganographic security label; and
a digital verification platform comprising a distributed ledger, wherein the machine-readable identifier is cryptographically bound to a digital record containing artwork provenance and ownership data,
wherein physical disruption of the steganographic security label alters the machine-readable identifier, thereby technically preventing digital verification of the artwork via the distributed ledger and providing a unified physical-digital tamper-evident mechanism.
